(19) United States
(12) Patent Application Publication
(10) Pub. No.: US 2023/0418683 A1
(43) Pub. Date: Dec. 28, 2023

(54) NODE MANAGEMENT FOR A CLUSTER

(71) Applicant: INTERNATIONAL BUSINESS MACHINES CORPORATION, ARMONK, NY (US)

(72) Inventors: Hai Hui Wang, Xian (CN); Xun Pan, XIAN (CN); Guangya Liu, Xian (CN); Xiang Zhen Gan, Xian (CN); Peng Li, Xian (CN)

(21) Appl. No.: 17/808,864

(22) Filed: Jun. 24, 2022

(51) Int. Cl. G06F 9/50; G06F 16/28

(52) U.S. Cl. CPC G06F 9/5083; G06F 16/285

(57) ABSTRACT

Disclosed are a computer-implemented method, a device and a computer program product of node management for a cluster of a cluster of computing nodes. A plurality of computing nodes in a cluster can be grouped into a hierarchy of groups according to a hierarchy of grouping policies. One of computing nodes in each group of the hierarchy of groups can be determined as a leader node of the corresponding group. A leader node of a first group can be responsible for collecting and reporting status of all computing nodes in the first group to a leader node of a second group superior to the first group by one level in the hierarchy of groups.

### BACKGROUND

The present disclosure relates generally to a cluster technique, and more specifically, to node management for a cluster of computing nodes.

A cluster is a set of computing nodes that work together so that they can be viewed as a single system, which allows for collaborative work on computationally intensive tasks instead of having to complete the tasks on a single computing node. By way of example, high performance computing (HPC) clusters are widely deployed to provide faster computing speed, higher scheduling efficiency, greater stability and reliability in order to solve complex problems and process vast amount of data in the fields of science, engineering, or business.

One of the challenges in the use of a cluster is the efficient management for the computing nodes in the cluster. For example, an administrator of a cluster may want to incorporate a large number of computing nodes in a cluster, such as hundreds or thousands of computing nodes; however, how to manage such a large number of computing nodes in an efficient way is challenging to the administrator.

### SUMMARY

According to one embodiment of the present disclosure, there is provided a computer-implemented method for node management. In this method, a plurality of computing nodes in a cluster can be grouped into a hierarchy of groups according to a hierarchy of grouping policies. One of computing nodes in each group of the hierarchy of groups can be determined as a leader node of the corresponding group. A leader node of a first group is responsible for collecting and reporting status of all computing nodes in the first group to a leader node of a second group superior to the first group by one level in the hierarchy of groups.

According to another embodiment of the present disclosure, there is provided a system for node management. The system comprises one or more processors, a memory coupled to at least one of the processors and a set of computer program instructions stored in the memory. When executed by at least one of the processors, the set of computer program instructions perform following actions. A plurality of computing nodes in a cluster can be grouped into a hierarchy of groups according to a hierarchy of grouping policies. One of computing nodes in each group of the hierarchy of groups can be determined as a leader node of the corresponding group. A leader node of a first group is responsible for collecting and reporting status of all computing nodes in the first group to a leader node of a second group superior to the first group by one level in the hierarchy of groups.

According to a yet another embodiment of the present disclosure, there is provided a computer program product for node management. The computer program product comprises a non-transitory computer readable storage medium having program instructions embodied therewith. The program instructions are executable by a processor to cause the processor to perform following actions. A plurality of computing nodes in a cluster can be grouped into a hierarchy of groups according to a hierarchy of grouping policies. One of computing nodes in each group of the hierarchy of groups can be determined as a leader node of the corresponding group. A leader node of a first group is responsible for collecting and reporting status of all computing nodes in the first group to a leader node of a second group superior to the first group by one level in the hierarchy of groups.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts a conventional architecture for node management in a cluster of computing nodes.

FIG. 5 depicts an exemplary hierarchical architecture for the node management according to an embodiment of the present disclosure.

FIG. 6 depicts an example of a hierarchy of grouping policies according to an embodiment of the present disclosure.

FIG. 7 depicts an exemplary schematic view of evolution of the cluster as more and more nodes are joined in the cluster according to an embodiment of the present disclosure.

FIG. 8 depicts an exemplary schematic view of dispatching workloads to one or more groups in the cluster according to an embodiment of the present disclosure.

FIG. 9 depicts a schematic view illustrating updating of the structure of the hierarchy of groups for the cluster according to an embodiment of the present disclosure.

FIG. 10 depicts a schematic view illustrating updating of the structure of the hierarchy of groups for the cluster according to another embodiment of the present disclosure.

FIG. 11 depicts a flowchart of a computer-implemented method of node management according to an embodiment of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

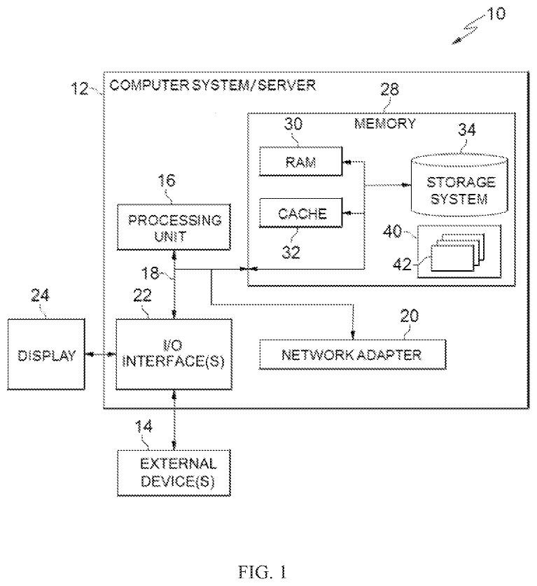

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

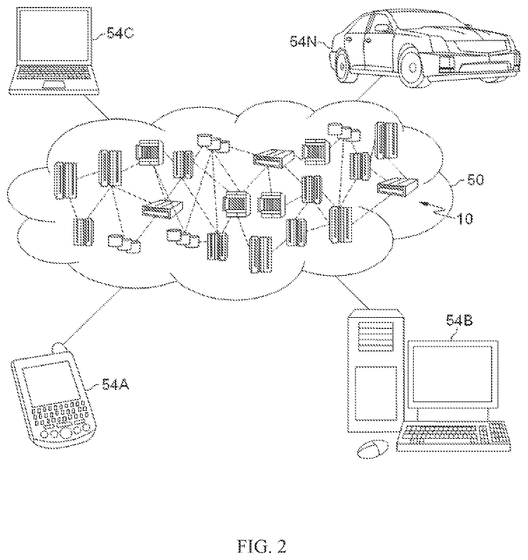

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

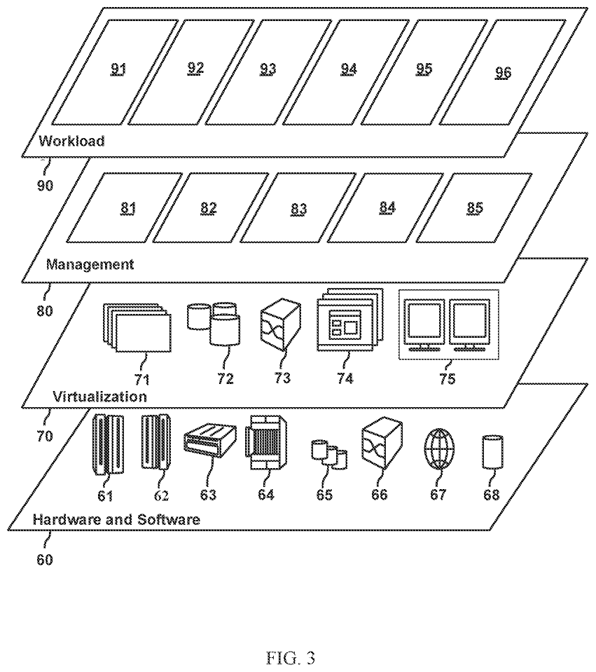

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and node management 96.

As mentioned in the above, in order to increase the speed of performing computationally intensive tasks and improve the efficiency of running workloads in a cluster of computing nodes, it is desirable to incorporate a large number of computing nodes in the cluster. A conventional cluster is usually preconfigured manually by an administrator, which is low efficient and costly. Moreover, it is difficult to add more computing nodes or re-group computing nodes to meet workload requirements or fully utilize node resources. Especially, as the number of the computing nodes in the cluster increases, it becomes difficult for the administrator to manage the computing nodes in an efficient way. The administrator should be familiar with the attributes of hardware and/or software of all the computing nodes in the cluster, and have a full understanding of both the current status and future development of the cluster, so as to build a suitable cluster based on his/her experience.

In addition, a management node in a cluster needs to collect status of all the computing nodes continuously for recording the up-to-date status of the entire cluster. In a conventional cluster, collecting the status of the computing nodes results in large overhead of network traffic since every computing node needs to report its status directly to the management node.

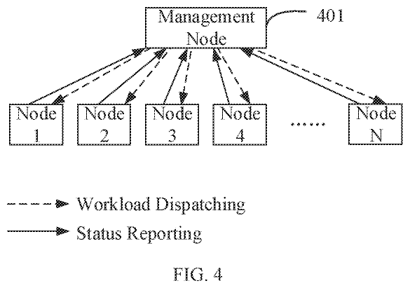

FIG. 4 depicts a conventional architecture for node management in a cluster of computing nodes.

As shown in FIG. 4, the conventional architecture for node management comprises a management node 401 and computing nodes 1 to N that are managed by management node 401. Each of management node 401 and the computing nodes 1-N may comprise any computing or processing device, such as blades, general-purpose personal computers (PC), workstations, or any other suitable computing devices. The conventional architecture is a flat structure. Each computing node 1-N in the cluster directly reports its status to management node 401 as represented in solid lines with arrow in FIG. 4, which costs large network bandwidth. In addition, management node 401 may select one or more computing nodes from computing nodes 1-N for execution of workloads and directly dispatch the workloads to each of the selected computing nodes, as represented in dashed lines with arrow in FIG. 4.

In view of the above, there exists a need for an improved node management approach to manage the computing nodes in an efficient way.

Embodiments of the present disclosure aim to solve at least one of the technical problems described above, and propose a method, system and computer program product for node management based on a hierarchical architecture instead of the flat structure. In the node management according to embodiments of the present disclosure, the cluster of computing nodes can be built automatically based on a hierarchy of grouping policies, and accordingly, the nodes can be grouped into a hierarchy of groups automatically. In addition, a leader node can be determined for each of the groups in the hierarchy of groups, and the leader node can be responsible for collecting and reporting status of all computing nodes in its group to the leader node of a group superior to this group by one level in the hierarchy of groups. In other words, a computing node may not report its status directly to the management node, but can report it to its leader node (referred to as a first leader). The first leader can report the status received from its member nodes as well as the status of the first leader itself to its leader node (referred to a second leader), and the second leader can report the status received from its member nodes as well as the status of the second leader itself to its superior node until the status reaches the management node. In such a way, the management node does not need to receive the status information directly from all the computing nodes, which reduces the bandwidth and burden of the management node. In addition, the leader node may also be responsible for receiving workloads dispatched from the management node and then allocating the workloads to its member nodes for execution, which may also reduce the bandwidth and burden of the management node. Further, the hierarchical architecture can be updated automatically with new nodes added or other changes, which can effectively reduce management difficulties for the cluster administrator.

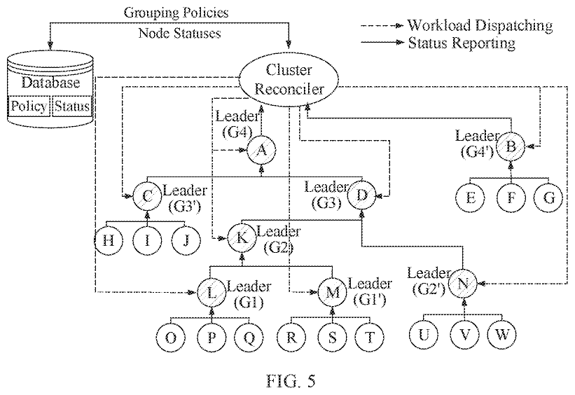

FIG. 5 depicts an exemplary hierarchical architecture for the node management according to an embodiment of the present disclosure. As shown in FIG. 5, the architecture includes a cluster reconciler, which can be a management node or part of a management node in a cluster and can be used interchangeably with the term of the management node throughout the specification.

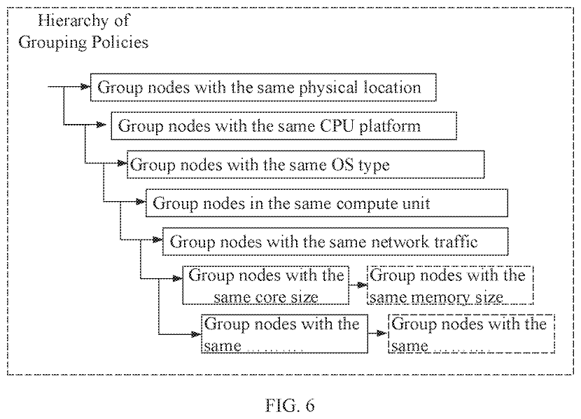

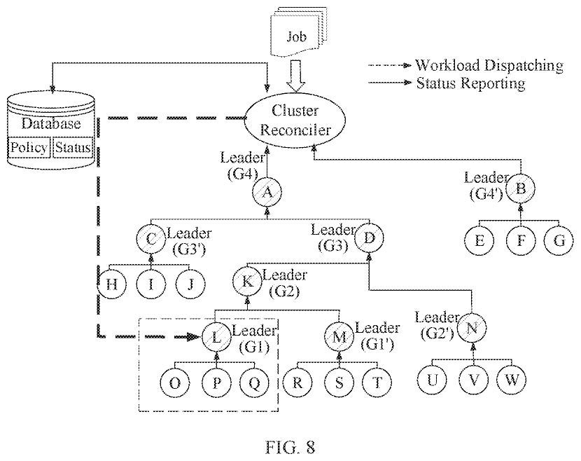

As shown in FIG. 5, the computing nodes in the cluster are grouped into a hierarchy of groups. The grouping can be performed according to a hierarchy of grouping policies. There can be various ways to obtain the hierarchy of grouping policies, for example, the grouping policies can be stored in a database accessible by the cluster reconciler and loaded into the cluster reconciler for use in grouping of the computing nodes into proper groups. Detailed descriptions of the grouping policies will be described later with reference to FIG. 6 and FIG. 8.

As shown in FIG. 5, for example, Group G1 at the bottom level of the hierarchy of the groups of the cluster may include Node L, Node O Node P and Node Q. Group G1′, which is also at the bottom level of the hierarchy, may include Node M, Node R, Node S and Node T. Along the upstream direction of the hierarchy, Group G2 is a group which is superior to Group G1 and Group G1′ by one level in the hierarchy of groups, wherein Group G2 can include all the nodes contained in group G1 and Group G1′ as well as Node K. Group G2′ is at the same level as the Group G2 in the hierarchy since they have the same superior Group G3 although Group G2′ does not have inferior groups. Group G2′ may include Node N, Node U, Node V and Node W. Moving upwards, Group G3 is superior to Group G2 and group G2′ by one level in the hierarchy of groups, and can include all the nodes contained in Group G2 and Group G2′ as well as Node D. Group G4 is superior to Group G3 and Group G3′ by one level in the hierarchy, and can include all the nodes contained in Group G3 and Group G3′ as well as Node A. Group G4 is also a group at the top level since its superior group would be the whole cluster. It can be seen that the groups of computing nodes are in a hierarchy with different levels.

The above illustrative architecture of the cluster according to the embodiments of the present disclosure is described with respect to a hierarchy of groups with four levels. Obviously, the number of levels of groups in the hierarchy, the number of computing nodes in each group, and the position of each group relative to the hierarchy of groups are just examples of the embodiments of the present disclosure, and do not limit the embodiments of the present disclosure to the above specific form of the above examples. Instead, more or less levels in the hierarchy of groups, different number of nodes contained in each group and different arrangements of the nodes relative to the hierarchy are possible.

Based on the grouping of the computing nodes into a hierarchy of groups, the cluster of computing nodes can be managed based on the hierarchy in an efficient way. In order to reduce the overhead related to the status reporting and/or workload dispatching and/or to improve the efficiency for scheduling the computing nodes for executing the dispatched workloads, one of computing nodes in each group of the hierarchy of groups can be determined as a leader node of the corresponding group. The leader node of a group (referred as a first group) can be responsible for collecting and reporting status of all computing nodes in the first group to the leader node of a group (referred as a second group) superior to the first group by one level in the hierarchy of groups. In such a way, a computing node may not report its status directly to the management node, but report it to its leader nodes. Then, the leader nodes report the status to the management node level by level. There can be various ways to determine the leader node for each of the groups, for example, the determination may be based on the workload status and/or the working performance of the computing nodes in a corresponding group. For example, the computing node with the lightest workload or the best working performance in the corresponding group may be selected as the leader node of the corresponding group.

Still referring to FIG. 5, in Group G1, Node L is selected as the leader node by the cluster reconciler, for example, based on the workload status and/or the working performance of all the computing nodes contained in Group G1. Similarly, in Group G2, Node K is selected as the leader node by the cluster reconciler; in Group G3, Node D is selected as the leader node by the cluster reconciler; and in Group G4, Node A is selected as the leader node by the cluster reconciler.

For example, the leader Node L can collect the status of all computing nodes in Group G1 and report them to the leader Node K of Group G2 which is superior to Group G1 by one level in the hierarchy of groups. Then, the leader Node K can collect and report the status of all computing nodes in Group G2 to the leader Node D of Group G3 which is superior to the Group G2 by one level in the hierarchy, and so on. Please understand that the leader Node K can collect the status of the computing nodes in Group G1 by receiving them from the leader Node L. Accordingly, the status of all the computing nodes in the cluster can be transmitted to the cluster reconciler through the leader nodes such as Nodes A and B of the groups at the top level. The leader nodes of the groups at the top level can directly transmit the collected status of the computing nodes to the cluster reconciler. The status can be finally stored in the database. In this manner, the burden for collecting the status of all the nodes contained in the cluster can be offloaded to the leader nodes of the groups in the hierarchy, which can reduce the overhead for network traffic and the work burden of the management node.

In another embodiment of the node management for the cluster, the workloads can be dispatched on a per-group basis. After receiving a job from a user, the management node can firstly determine one or more groups of computing nodes suitable for the job on a per-group basis. For example, the management node can determine a proper group of computing nodes (e.g., the first group) from the hierarchy of groups for executing a job received from a user, and the management node can accordingly dispatch workloads to the leader node of the first group for execution by one or more computing nodes in the first group, instead of having to directly dispatch the workloads to every one of the selected nodes to execute. In this manner, the efficiency for dispatching the workloads to the cluster can be improved. For example, as shown in FIG. 5, when Group G1 is determined as the proper group for executing the workloads, the cluster reconciler can dispatch the workloads to the leader node (i.e., Node L) of Group G1, and then the Node L can allocate the received workloads to itself and/or its member nodes, such as Node O, Node P and Node Q. It should be noted that the selected group can be a group at any level rather than only a group at the bottom level. For example, the selected group can be Group G2, and the management node can dispatch the workloads to the leader Node K. In such a case, the leader Node K can dispatch the workloads to itself and/or the nodes in Group G1 and Group G1′. For example, Node K may first allocate the workloads to itself, and if Node K finds it has no enough computing resources, it may dispatch part of the workloads to one or more nodes directly inferior to it in the hierarchy such as Node L and/or Node M.

FIG. 6 is an example of a hierarchy of grouping policies according to an embodiment of the present disclosure. In the hierarchy of grouping policies, there can be one or more grouping polices in each level of the hierarchy. The grouping policy in each level can be used to determine computing nodes in each level of groups. Each of the grouping policies can be associated with an attribute of the computing nodes in the cluster, for example, an attribute related to the hardware or software properties of the computing nodes. For example, the grouping policy of each level in the hierarchy of grouping policies can be based on at least one selected from a group comprising a physical location, a central processing unit (CPU) platform, an operating system (OS) type, a compute unit (CU), a network traffic, a core size, a memory size, and a customized attribute.

As shown in FIG. 6, at the top level of the hierarchy of grouping policies, the grouping policy requires that nodes with the same location are grouped together, for example, computing nodes located at a first position and computing nodes located at a second position are grouped into two different groups.

Then, at the next level, the grouping policy requires that nodes with the same CPU platform are grouped together. For example, CPU platforms may include x86, ARM, and the like. Since the grouping based on the CPU platform is at a level lower than the level for grouping based on the location, the grouping based on the CPU platform is performed within each group with computing nodes at the same location. For example, for the group of computing nodes at the first position, it will be sub-divided to a group of computing nodes with the x86 platform and a group of computing nodes with the ARM platform. The same principle applies for the group of computing nodes at the second position.

Similarly, the grouping policies at other levels may require that nodes with the same OS type, with the same CU, or with the same network traffic are grouped together. For example, OS types may include Windows, Linux and the like. The compute unit may refer to a physical rack where the computing nodes are located. The network traffic may refer to the speed of the network card used in the computing nodes. In addition to the grouping policies related to the attributes of the computing nodes listed above, the grouping policy can be based on any customized attribute. The present disclosure does not restrict the specific attributes of the computing nodes for the hierarchy of the grouping policies.

The above examples for the grouping polices are directed to the cases where there is only one grouping policy at each level of the hierarchy of the grouping policies, but embodiments of the present disclosure are not limited thereto. There may be more than one grouping policies at a level of the hierarchy. For example, as shown in FIG. 6, the grouping policy which requires that nodes with same core size are grouped together and the grouping policy which requires that nodes with the same memory size are grouped together can be at the same level, but only one of them can be selected as the grouping policy at a particular point of time.

The above illustrative architecture as shown in FIG. 6 is only an example of the hierarchy of grouping policies according to embodiments of the present disclosure. The present disclosure is not limited to the shown structure. For example, there may be more or less levels in the hierarchy of grouping polices, and different level orders of the grouping polices may be used. In addition, different grouping polices than those as shown in FIG. 6 may be used at one or more levels of the hierarchy of grouping polices.

Referring back to FIG. 5 in combination with FIG. 6, the hierarchy of groups corresponds to the hierarchy of grouping polices. For example, Group G4 and Group G4′ at the top level of the hierarchy of groups correspond to the grouping policy at the top level of the hierarchy of grouping policies, and thus Group G4 and Group G4′ are at different geographic positions. Group G3 and Group G3′ at the second level of the hierarchy of groups are at the same geographic position but with different CPU platforms. Subsequently, Group G2 and Group G2′ are with the same CPU platform but different OS types, and Group G1 and Group G1′ are with the same OS type but different compute units. Accordingly, based on the hierarchy of grouping policies, each of the computing nodes can be groups into corresponding groups in the hierarchy of groups.

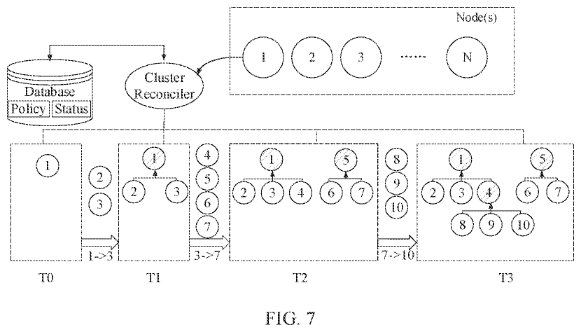

FIG. 7 shows an exemplary schematic view of evolution of the cluster as more nodes are joined in the cluster according to an embodiment of the present disclosure. It should be noted that the embodiment of the present disclosure can be applicable both to the case where a patch of computing nodes is joined in a cluster at the initialization stage for building the cluster and the case where one or more new computing nodes are added to the cluster after the cluster has been built. According to embodiments of the present disclosure, each of the computing nodes can be grouped into a hierarchy of groups based on the hierarchy of grouping policies.

According to the illustrative example of FIG. 7, the database may store a hierarchy of grouping policies for use by the reconciler in determination of the groups for each of the computing nodes. Accordingly, the cluster reconciler can load the grouping policies to generate a built-in policies layer therein to perform node grouping process based on the grouping policies. The computing nodes to be added into the cluster can be processed by the built-in policies layer to be grouped into proper groups in the hierarchy. The built-in policies layer can perform the node grouping process to determine groups for each computing node based on the attributes of the corresponding computing node considering the grouping policies at each level of the hierarchy of the grouping polices.

As shown in FIG. 7, at time T0, the first one node (e.g., Node 1) is added into the cluster, which can occur when the cluster is initially built. At a later time T1, two more nodes (e.g., Nodes 2-3) may join in the cluster, and each computing node newly added to the cluster can be grouped into the hierarchy of groups according to the hierarchy of grouping policies. In other words, based on the hierarchy of grouping policies loaded from the database, the cluster can be structured as a hierarchy of groups, and the newly added two nodes can be grouped into respective group(s). In the example of FIG. 7, one group is built and one node (e.g., the shadowed Node 1) from the three nodes is determined as the leader node. Subsequently, at time T2, four more nodes (e.g., Nodes 4-7) may join in the cluster, and based on the hierarchy of policing groups, two groups with respective leader nodes can be built and the newly added four nodes can be grouped into the two groups. For example, Node 4 may be added to the originally built group as its member node, while Nodes 5-7 may form a new group with Node 5 being selected as its leader node. At time T3, three more nodes (e.g., Nodes 8-10) may join in the cluster, and three groups with respective leader nodes can be built and the newly added three nodes can be grouped into the three groups. For example, another new group including Nodes 4, and 8-10 may be formed with Node 4 selected as its leader node. In this manner, the cluster can be built and managed based on a hierarchical mechanism for a large amount of computing nodes, and the grouping can be performed automatically based on the hierarchy of grouping policies, instead of having to be pre-configured manually based on the administrator's experience and knowledge.

In order to determine the groups to which each computing node belongs, for example, attributes of each computing node can be compared with the attributes involved in the hierarchy of grouping policies such that all computing nodes in the same node group are with the same attributes.

FIG. 8 shows an exemplary schematic view of dispatching workloads to one or more groups in the cluster according to an embodiment of the present disclosure.

In an embodiment, workloads can be dispatched to one or more groups based on a criterion corresponding to a grouping policy in the hierarchy of grouping policies. In other words, the workloads can be dispatched based on groups, and the selection of groups can be related to the grouping policies for dividing the groups. For example, the criteria can be that the workloads should be executed at a particular geographic position, using a particular CPU platform, and/or using a particular OS type. The criteria may be input by a user into the cluster reconciler, or be determined by the cluster reconciler based on for example the nature of the workloads to be executed. As shown in FIG. 8, the cluster reconciler may receive one or more jobs from a user. Upon receipt of the job request, the cluster reconciler may determine the criteria related to the grouping policies according to the nature of the jobs, and then select one or more groups for executing the workloads (for example, Group G1) based on the determined criteria. Selecting the one or more groups may be further based on the collected status of the computing nodes in the cluster. Afterwards, the cluster reconciler may dispatch the workloads to the leader Node L of the selected Group G1 such that the leader Node L can allocate the received workloads to one or more member nodes of Group G1 for execution.

It is noted that the dispatching can be at any level of the hierarchy, for example, a workload may also be dispatched to Group G4 at the top level or Group G3 at the second level. In addition, a workload can also be dispatched to two or more groups, for example, Group G3′ and Group G4′. Further, the criteria for determining the one or more suitable groups can be obtained in various ways. For example, a job request from the user may also indicate execution requirements for the job, and the execution requirements can be used as the criteria for determining the suitable groups.

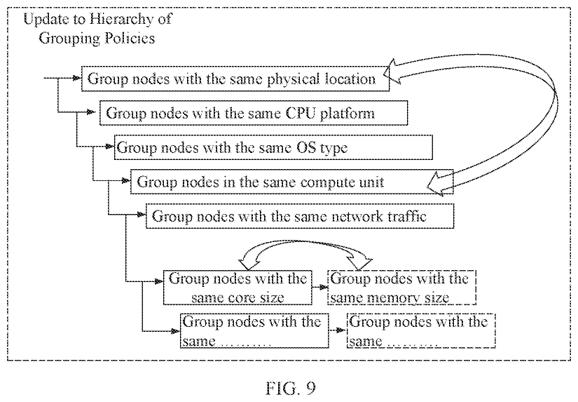

FIG. 9 is a schematic view illustrating updating of the structure of the hierarchy of groups for a cluster according to an embodiment of the present disclosure. According to embodiments of the present disclosure, updating of the hierarchy of groups may be caused by changes in the hierarchy of grouping policies.

In an embodiment, the hierarchy of groups may be updated in response to changing levels of at least two grouping policies in the hierarchy of grouping policies. As shown in FIG. 9, the grouping policy of “Group nodes with the same location” at the top level can be exchanged with the grouping policy of “Group nodes in the same compute unit” at the fourth level.

In another embodiment, the hierarchy of groups may be updated in response to replacing a grouping policy at a level in the hierarchy of grouping policies with a different grouping policy. For example, the replacement of a grouping policy at a particular level with another grouping policy may occur in the case where there are more than one grouping policy at the particular level of the hierarchy. Also as shown in FIG. 9, in each of the bottom two layers of the hierarchy of the grouping polices, there are two grouping polices in the same level of the hierarchy. At a particular point of time, there can be only one grouping police enabled, which can be determined depending on priorities of the two grouping policies. In such a case, updating of the hierarchy of grouping policies may be caused by change of priorities assigned to the grouping policies at the same level.

According to the above embodiments, the present disclosure provides a dynamic hierarchical grouping mechanism in a cluster. When the structure of a cluster needs to be changed due to for example dynamic requirements of the user or updates of the computing nodes in the cluster, the hierarchy of groups can be updated automatically by updating the hierarchy of grouping policies without re-configuring the cluster manually by the administrator. It enables dynamic and flexible node management for a cluster.

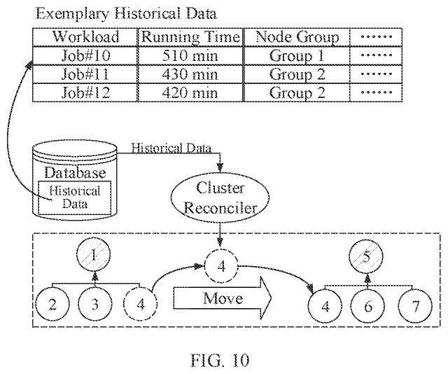

FIG. 10 is a schematic view illustrating updating of the structure of the hierarchy of groups for a cluster according to another embodiment of the present disclosure. According to the embodiment of the present disclosure, updating of the hierarchy of groups may be based on historical workload running performance of the cluster.

As shown in FIG. 10, historical data related to the historical workload running performance of the cluster can be stored in the database, and the historical data can be used by the cluster reconciler to determine inter-group movement of one or more computing nodes in the cluster. For example, the historical data may comprise running time of each group for each job. According to the historical data, it can be determined that some group may have too much workload and the performance of the cluster will be improved if a computing node in another group with less workload is moved to the group. As shown in FIG. 10, the node group on the left may originally include Nodes 1-4 among which Node 1 is selected as its leader node, and the node group on the right may originally include Nodes 5-7 among which Node 5 is selected as its leader node. However, based on analysis of the historical workload running performance of the cluster, it may be determined that the performance of the cluster will be improved if a computing node (e.g., Node 4 represented by a dashed circle) in the left group is moved to the right group. Accordingly, the cluster reconciler may update the hierarchy of groups by moving Node 4 from the left group to the right group. It is noted that the historical workload running performance may also comprise other information, and the determination of node movement may be determined on other criteria. For example, when a specific workload needs to be dispatched, the cluster reconciler determines, based on the historical workload running performance for a similar workload, that the workload will be performed more efficiently in a group if a computing node in another group is moved to the group.

Further, it should be noted that there can be various ways to perform the analysis of the historical data. For example, an artificial-intelligence or machine learning component can be employed in the cluster reconciler to analyze the historical workload running performance in order to decide movement of one or more computing nodes from one group to another group.

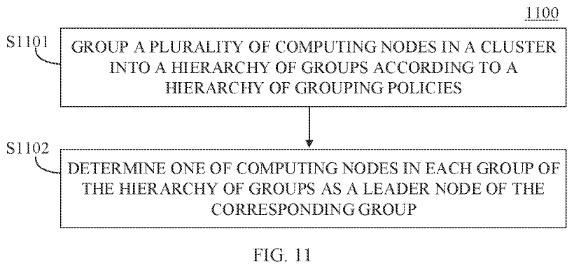

FIG. 11 shows a flowchart of a computer-implemented method 1100 of node management according to an embodiment of the present disclosure. The detailed description of method 1100 can refer to the content described in the above with respect to FIGS. 1-10. For example, method 1100 can be executed by the cluster reconciler described with respect to FIG. 5, FIG. 7, FIG. 8 and FIG. 10, which acts as a management node of a cluster. Each step of method 1100 can be performed by one or more processing units, such as central processing unit (CPU) in the cluster reconciler.

With reference to FIG. 11, method 1100 comprises steps 1101-1102. At step 1101, computing nodes in a cluster can be grouped into a hierarchy of groups according to a hierarchy of grouping policies. As an example, the computing nodes of a cluster may be grouped in a hierarchy of groups as shown in FIG. 5. The hierarchy of grouping policies can be of any hierarchy and related to any attributes of the computing nodes, such as the hierarchy of grouping policies described with respect to FIG. 6. For example, the grouping policy of each level in the hierarchy of grouping policies can be based on at least one selected from a group comprising a physical location, a central processing unit (CPU) platform, an operating system (OS) type, a compute unit (CU), a network traffic, a core size, a memory size, and a customized attribute. In an embodiment, the grouping step may include grouping each computing node newly added to the cluster into the hierarchy of groups according to the hierarchy of grouping policies, such as described with respect to FIG. 7. Therefore, the node grouping process may be performed automatically based on the hierarchy of grouping policies, rather than manually configured by the cluster's administrator.

At step 1102, one of computing nodes in each group of the hierarchy of groups can be determined as a leader node of the corresponding group. For example, determining one of computing nodes in each group of the hierarchy of groups as a leader node of the corresponding group can be based on the workload status and/or the working performance of the computing nodes in the corresponding group. Further, a leader node of a first group can be responsible for collecting and reporting status of all computing nodes in the first group to a leader node of a second group superior to the first group by one level in the hierarchy of groups. The first group can be any group in the hierarchy of groups. If the first group is at the top level, it reports the status of all computing nodes in the first group to the management node.

Optionally, the method 1100 can also comprise a step of dispatching a workload to one or more groups based on a criterion corresponding to a grouping policy in the hierarchy of grouping policies. For example, the workload can be dispatched to the leader node of the first group for execution by one or more computing nodes in the first group. Detailed description of dispatching workload to one or more groups of the cluster can refer to the content described with respect to FIG. 8.

Optionally, the method 1100 can also comprise a step of updating the hierarchy of groups in response to updating of the hierarchy of grouping policies. As an example, the updating of the hierarchy of grouping policies comprises changing levels of at least two grouping policies in the hierarchy of grouping policies. Additionally or alternatively, the updating of the hierarchy of grouping policies comprises replacing a grouping policy at a level in the hierarchy of grouping policies with a different grouping policy. Detailed description of updating of the hierarchy of grouping policies can refer to the content described with respect to FIG. 9.

Optionally, the method 1100 can also comprise a step of updating the hierarchy of groups according to historical workload running performance of the cluster. Detailed description can refer to the content described with respect to FIG. 10.

It should be noted that the processing of the method of node management as described hereinbefore according to embodiments of this disclosure can be implemented by a system such as computer system/server 12 of FIG. 1. Accordingly, the computer system/server 12 of FIG. 1 may function as a system of node management comprising one or more processors and a memory coupled to at least one of the processors. A set of computer program instructions are stored in the memory, e.g., memory 28 of FIG. 1. When executed by at least one of the processors, e.g., processing units 16 of FIG. 1, the set of computer program instructions perform following series of actions. A plurality of computing nodes in a cluster can be grouped into a hierarchy of groups according to a hierarchy of grouping policies. One of computing nodes in each group of the hierarchy of groups can be determined as a leader node of the corresponding group. A leader node of a first group is responsible for collecting and reporting status of all computing nodes in the first group to a leader node of a second group superior to the first group by one level in the hierarchy of groups.

In an embodiment, each computing node newly added to the cluster can be grouped into the hierarchy of groups according to the hierarchy of grouping policies.

In an embodiment, a workload can be dispatched to one or more groups based on a criterion corresponding to a grouping policy in the hierarchy of grouping policies.

In an embodiment, a workload can be dispatched to the leader node of the first group for execution by one or more computing nodes in the first group.

In an embodiment, the hierarchy of groups can be updated in response to updating of the hierarchy of grouping policies. In one example for updating of the hierarchy of grouping policies, levels of at least two grouping policies in the hierarchy of grouping policies can be changed. In another example for updating of the hierarchy of grouping policies, a grouping policy at a level in the hierarchy of grouping policies can be replaced with a different grouping policy.

In an embodiment, the hierarchy of groups can be updated according to historical workload running performance of the cluster.

In an embodiment, the grouping policy of each level in the hierarchy of grouping policies can be based on at least one selected from a group comprising a physical location, a central processing unit (CPU) platform, an operating system (OS) type, a compute unit (CU), a network traffic, a core size, a memory size, and a customized attribute.

In an embodiment, the determining one of computing nodes in each group of the hierarchy of groups as a leader node of the corresponding group can be based on the workload status and/or the working performance of the computing nodes in the corresponding group.

The descriptions above related to the process of method 1100 can also be applied to the system of node management, and details are omitted herein for conciseness.

In addition, according to another embodiment of the present disclosure, a computer program product for feature processing is disclosed. As an example, the computer program product comprises a non-transitory computer readable storage medium having program instructions embodied therewith, and the program instructions are executable by a processor. When executed, the program instructions cause the processor to perform one or more of the above described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for node management, comprising:
grouping, by one or more processing units, a plurality of computing nodes in a cluster into a hierarchy of groups according to a hierarchy of grouping policies; and
determining, by the one or more processing units, one of the plurality computing nodes in each group of the hierarchy of groups as a leader node of the corresponding group, wherein the leader node of a first group is responsible for collecting and reporting status of all computing nodes in the first group to the leader node of a second group superior to the first group by one level in the hierarchy of groups.

2. The computer-implemented method of claim 1, wherein the grouping the plurality of computing nodes in the cluster into the hierarchy of groups according to a hierarchy of grouping policies further comprises:
grouping, by the one or more processing units, each computing node newly added to the cluster into the hierarchy of groups according to the hierarchy of grouping policies.

3. The computer-implemented method of claim 1, further comprises:
dispatching, by the one or more processing units, a workload to one or more groups based on a criterion corresponding to a grouping policy in the hierarchy of grouping policies.

4. The computer-implemented method of claim 1, further comprises:
dispatching, by the one or more processing units, a workload to the leader node of the first group for execution by one or more computing nodes in the first group.

5. The computer-implemented method of claim 1, further comprises:
updating, by the one or more processing units, the hierarchy of groups in response to updating of the hierarchy of grouping policies.

6. The computer-implemented method of claim 5, wherein the updating of the hierarchy of grouping policies comprises:
changing levels of at least two grouping policies in the hierarchy of grouping policies; and
replacing a grouping policy at a level in the hierarchy of grouping policies with a different grouping policy.

7. The computer-implemented method of claim 1, further comprises:
updating, by the one or more processing units, the hierarchy of groups according to historical workload running performance of the cluster.

8. The computer-implemented method of claim 1, wherein the grouping policy of each level in the hierarchy of grouping policies is based on at least one selected from a group comprising a physical location, a central processing unit (CPU) platform, an operating system (OS) type, a compute unit (CU), a network traffic, a core size, a memory size, and a customized attribute.

9. The computer-implemented method of claim 1, wherein the determining one of the plurality of computing nodes in each group of the hierarchy of groups as the leader node of the corresponding group is based on a workload status and a working performance of the computing nodes in the corresponding group.

10. A system for node management, comprising:
one or more processors;
a memory coupled to at least one of the processors; and
a set of computer program instructions stored in the memory, which, when executed by at least one of the processors, perform actions of:
grouping a plurality of computing nodes in a cluster into a hierarchy of groups according to a hierarchy of grouping policies; and
determining one of the plurality of computing nodes in each group of the hierarchy of groups as a leader node of the corresponding group, wherein the leader node of a first group is responsible for collecting and reporting status of all computing nodes in the first group to the leader node of a second group superior to the first group by one level in the hierarchy of groups.

11. The system of claim 10, wherein the grouping the plurality of computing nodes in the cluster into the hierarchy of groups according to the hierarchy of grouping policies further comprises:
grouping each computing node newly added to the cluster into the hierarchy of groups according to the hierarchy of grouping policies.

12. The system of claim 10, wherein the set of computer program, when executed by the at least one of the processors, further perform actions of:
dispatching a workload to one or more groups based on a criterion corresponding to a grouping policy in the hierarchy of grouping policies.

13. The system of claim 10, wherein the set of computer program, when executed by the at least one of the processors, further perform actions of:
dispatching a workload to the leader node of the first group for execution by one or more computing nodes in the first group.

14. The system of claim 10, wherein the set of computer program, when executed by the at least one of the processors, further perform actions of:
updating the hierarchy of groups in response to updating of the hierarchy of grouping policies.

15. The system of claim 14, wherein the updating of the hierarchy of grouping policies comprises:
changing levels of at least two grouping policies in the hierarchy of grouping policies; and
replacing a grouping policy at a level in the hierarchy of grouping policies with a different grouping policy.

16. The system of claim 10, wherein the set of computer program, when executed by the at least one of the processors, further perform actions of:
updating the hierarchy of groups according to historical workload running performance of the cluster.

17. The system of claim 10, wherein the grouping policy of each level in the hierarchy of grouping policies is based on at least one selected from a group comprising a physical location, a central processing unit (CPU) platform, an operating system (OS) type, a compute unit (CU), a network traffic, a core size, a memory size, and a customized attribute.

18. The system of claim 10, wherein the determining one of computing nodes in each group of the hierarchy of groups as the leader node of the corresponding group is based on a workload status and a working performance of the computing nodes in the corresponding group.

19. A computer program product for node management, the computer program product comprising a non-transitory computer readable storage medium having program instructions embodied therewith, the program instructions executable by a processor to cause the processor to:
group a plurality of computing nodes in a cluster into a hierarchy of groups according to a hierarchy of grouping policies; and
determine one of the plurality of computing nodes in each group of the hierarchy of groups as a leader node of the corresponding group, wherein the leader node of a first group is responsible for collecting and reporting status of all computing nodes in the first group to the leader node of a second group superior to the first group by one level in the hierarchy of groups.

20. The computer program product of claim 19, wherein the program instructions executable by the processor to further cause the processor to:
update the hierarchy of groups in response to updating of the hierarchy of grouping policies.
